(19) United States
(12) Patent Application Publication
(10) Pub. No.: US 2015/0106398 A1
(43) Pub. Date: Apr. 16, 2015

(54) JEWELRY PIECE WITH GRAPHICAL DISPLAY

(71) Applicant: FashionTeq, Inc., Ladera Ranch, CA (US)

(72) Inventors: Micahel David Tomlinson, Aliso Viejo, CA (US); Judith Ann Tomlinson, Aliso Viejo, CA (US)

(21) Appl. No.: 14/514,013

(22) Filed: Oct. 14, 2014

Related U.S. Application Data
(60) Provisional application No. 61/890,196, filed on Oct. 12, 2013.

(51) Int. Cl. A44C 15/00; A44C 9/00; G06F 17/30; A44C 5/00

(52) U.S. Cl. CPC A44C 15/0015; A44C 5/0007; A44C 9/0053; A44C 15/005; G06F 17/30259
USPC 707/769; 63/1.11

(57) ABSTRACT

A jewelry piece for displaying images is disclosed that includes a graphical display configured to display a plurality of images, a casing configured to house the graphical display and configured to mount to an object to form the jewelry piece, and a processor configured to receive a notification from a computing device and output an image on the graphical display based on the received notification.

### CROSS-REFERENCE TO RELATED APPLICATION

This application claims priority to U.S. Provisional Application No. 61/890,196, filed Oct. 12, 2013, the entire contents of which are incorporated herein by reference in their entireties.

### TECHNICAL FIELD

The present invention relates to systems and methods for displaying images on a wearable device. More specifically, the present invention relates to systems and methods for displaying images on a piece of jewelry in response to a notification received from a computing device.

### BACKGROUND

Currently wearable devices are becoming more popular. For example, several different wearable devices are available which have displays that are in communication with one or more computing devices (e.g., smart phones, tablets, or personal computers). These wearable devices have several uses, such as a timekeeping device, i.e., a smart watch. Typically, smart watches can, among other features, receive notifications from computing devices and display the text of those notifications.

However, problems exist with the current wearable devices. For example, may wearable devices only display a text representation of the notifications that they receive. By the nature of a wearable device, these text displays are easily seen by other people, and are not private to the person wearing the device. This can be inconvenient, embarrassing or can cause other undesired consequences due to an unintended viewer reading the message. Moreover, generally, these wearable devices are not aesthetically pleasing, as they appear more like a cumbersome electronic gadget than an elegant piece of apparel.

There is, therefore, a need for wearable devices that are able to present notifications to users in a discrete manner, so the owner of the wearable device can avoid the problems of others seeing their private messages. Additionally, there is a need for a wearable device that presents aesthetically pleasing images rather than plain text and/or looks aesthetically pleasing, so the device will be more appealing to the user.

### SUMMARY

It is an object of the present invention to provide systems and methods for displaying images in a user-defined manner on a piece of jewelry in response to notifications being sent to the piece of jewelry by a computing device in an aesthetically pleasing, functional and discrete manner.

The systems and method of the present invention center around the innovative concept of displaying images on a wearable device and providing a way for the displayed image to be changed when a notification is sent from a computing device. The user of the wearable can configure what images they would like to see, and what classification of notifications should display which images. This configuration will be performed through the computing device or through some other external device.

The images and other configuration information may be downloaded to the wearable device and stored in persistent storage on the wearable device. When a notification is sent from the computing device to the wearable device, the wearable device looks up in its configuration data to see which image the user would like to be displayed, and presents that image on the display. The wearable device may also contain lights or vibrator motors, which can also be configured to flash or vibrated in predefined manner for each classification of notification. This allows the user to select personally pleasing images that they would like to see, and associate those images in a personally pleasing manner with notifications that may be presented by the computing device.

In this manner, one or more of the following beneficial features may be achieved. All notifications may be discrete by image, graphic, light and/or vibration, and the user can decide the meaning of the notification. The user may be the only one who knows the meaning of the image, light, and/or vibration that is displayed. The notifications may only be seen and/or felt the user. The image may be used as an indicator of the class of notification, e.g. email, text, voicemail or web message such as an social media message. A default image may be defined by the user, so at all times a personally pleasing image may be displayed on the wearable device. An image may be selected by the user for each type of notification. For example, a silent ringtone image may be displayed for a short time to give the user the notification only, then the display may return to the default image that the user selected for the jewelry display; or a ringtone light and vibration may be presented for a user-defined duration to give the user the notification.

An application may send via wireless connection, a user-defined notification and/or action (e.g., light, vibration, or image) for a phone call, VIP phone call, text, email, and/or web status that may be downloaded and stored on the wearable device, for storing the logic of user's choices of notifications. The application may send all actions to the wearable device. The wearable device may listen and filter all notifications given and execute predetermined governed notifications set by user's configuration. The wearable device may include a jewelry bracelet (e.g., band or change) that may be interchangeable with different colors so that users can wear the same wearable device and change the jewelry bracelet to their liking of that day. The wearable device may include a pendant so that one can wear the wearable device around their neck. The wearable device may include ring so that one can wear the wearable device on their hand. The wearable device may have extra elements that can clip on or around the wearable device as an extra enhancement. The wearable device may include accessories, including a belt buckle, a broach, a tie-clip, ear-rings, a finger ring, a name-tag for pet, and/or a luggage tag.

### BRIEF DESCRIPTION OF THE DRAWINGS

FIG. 1 shows a schematic view of a system for displaying an image on a jewelry piece, according to an exemplary embodiment;

FIG. 2 shows a schematic view of a jewelry piece for displaying an image, according to an exemplary embodiment;

FIG. 3 shows a notification look up table stored in a jewelry piece, according to an exemplary embodiment;

FIG. 4 shows an image look up table stored in a jewelry piece, according to an exemplary embodiment;

FIG. 5 shows a notification look up table stored in the jewelry piece, according to another exemplary embodiment;

FIG. 6 shows an image look up table stored in a jewelry piece, according to another exemplary embodiment;

FIG. 7 shows methods for creating an image look up table and a notification look up table, according to exemplary embodiments;

FIG. 8 shows a method for processing notifications on a jewelry piece, according to an exemplary embodiment;

FIG. 9A shows components in a jewelry piece, according to an exemplary embodiment;

FIG. 9B shows components of a casing of the jewelry piece of FIG. 9A, according to an exemplary embodiment;

FIGS. 10A and 10B illustrate the casing of FIG. 9B mounted on a bracelet and ring, respectively, according to exemplary embodiments;

FIG. 11 shows the casing of FIG. 9B mounted on a pendant, according to an exemplary embodiment; and

FIG. 12 shows the casing of FIG. 9B mounted in a variety of manners, according to exemplary embodiments.

### DETAILED DESCRIPTION

The present invention provides for systems and methods of displaying an image on a wearable device, such as a piece of jewelry. It should be noted that the present invention may not be limited to jewelry and/or wearable devices. Rather, the present invention may be any device configured to display images and communicate with a computing device.

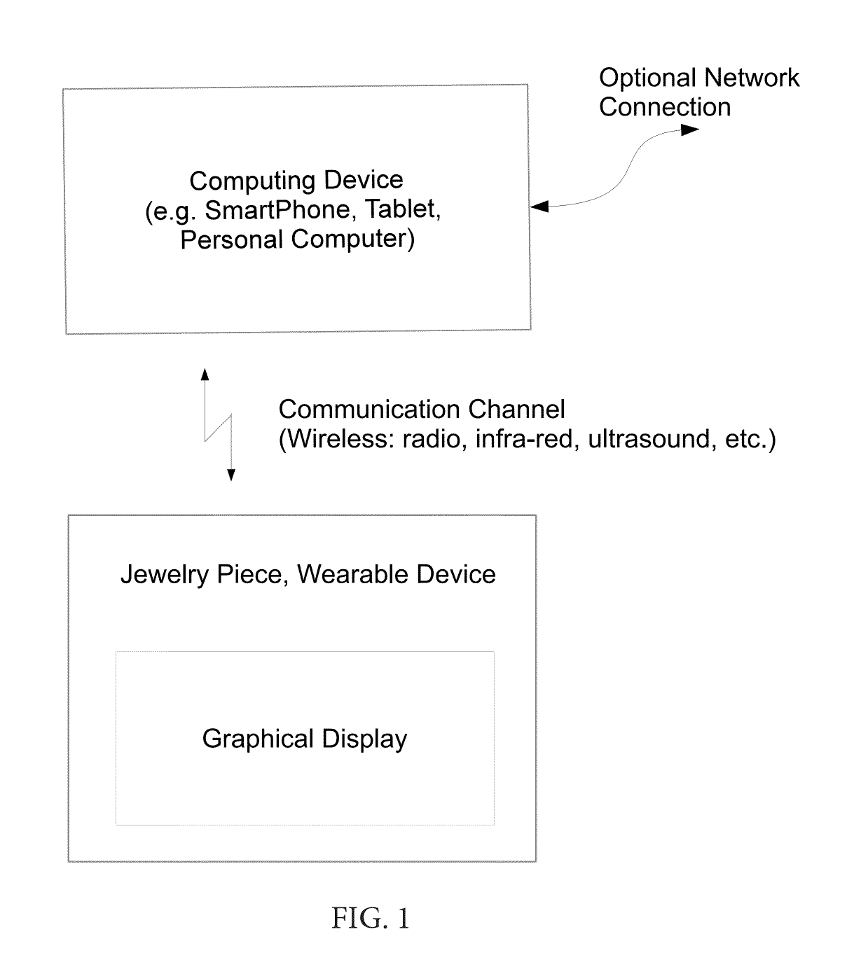

FIG. 1 shows a schematic view of a system for displaying an image on a jewelry piece, according to an exemplary embodiment. As illustrated in FIG. 1, the system may include a computing device, including, but not limited to, a smartphone, a tablet computer, a personal computer, and/or other similar computing device. The computing device may be connected to a wearable device, such as a jewelry piece via any electronic communication known to one skilled in the art, including, but not limited to, Bluetooth, WiFi, Zigbee, infra-red methods, and/or ultrasound methods. FIG. 1 further illustrates that in some embodiments, the computing device may be connected to a network, such as the internet. This allows the computing device to gather information from the network and/or allows for messages to be sent to the computing device over the network.

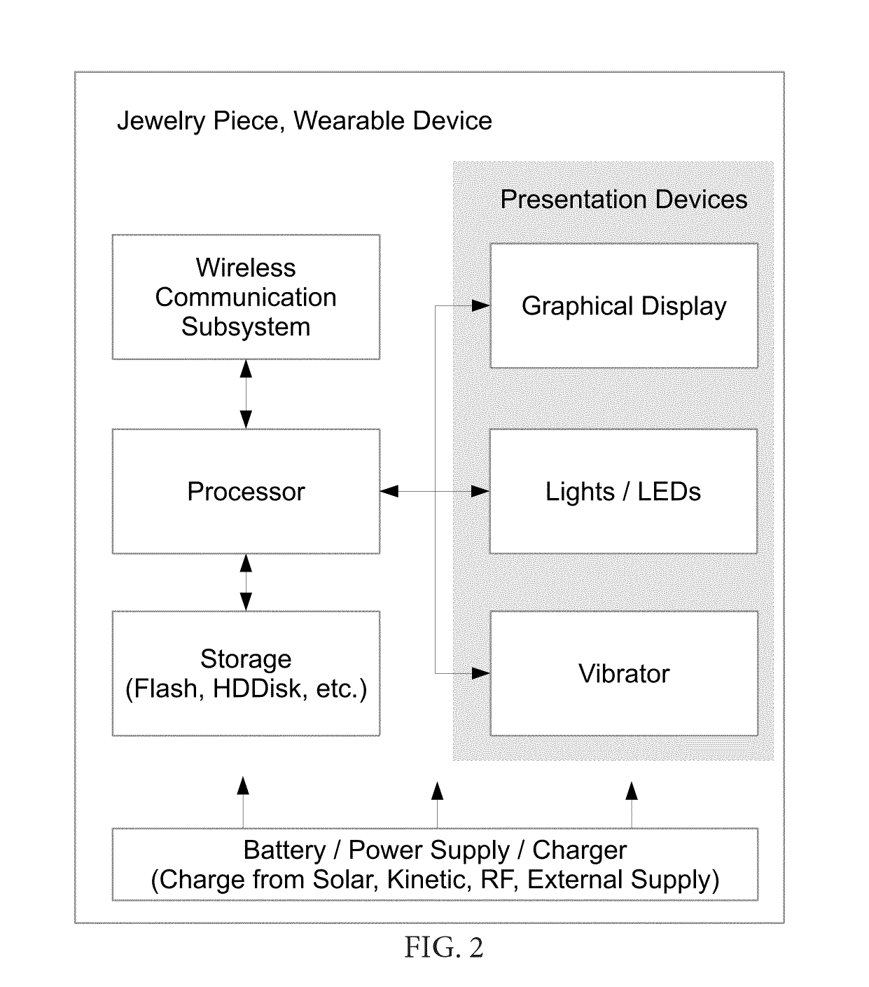

In some embodiments, the jewelry piece may include an electronic subsystem. For example, FIG. 2 illustrates an electronic subsystem of a jewelry piece, according to an exemplary embodiment. As illustrated in FIG. 2, the electronic subsystem may include a graphical display that may be configured to be seen by the user and display images that the user chooses. The electronic subsystem additionally includes a wireless communication subsystem that may be configured to communicate with the computing device using chosen protocols, such as Bluetooth. The electronic subsystem may also include a power supply, such as a battery, charger, and/or any power supply known to those skilled in the art. In some embodiments, the electronic subsystem may include a means for charging the power supply, including, but not limited to, solar, kinetic, RF, and/or an external supply.

As shown in FIG. 2, the Electronic Subsystem may also include a processor and a storage. The processor may be configured to execute a program stored in the storage. The program may be configured to allow the processor to control all the other subsystems in the electronic subsystem. In particular the program may be configured to communicate through the wireless subsystem to send and receive messages from the computing device, read and write data into the storage (including the Notification Lookup Tables and the Image Lookup Tables), write images to the graphical display, control the Lights/LEDs to change brightness, color and flashing, and/or control the vibrator to vibrate when needed so the user can feel the vibration. The graphical display, lights/LEDs, and vibrator are collectively called the presentation devices as they present information to the user in various different ways.

The graphical display can use one of many different display technologies, such as LEDs, OLEDs, and/or LCD. In some embodiments, the graphical display may use ePaper display technology, which is advantageous, because it may be completely disconnected from the power supply when the image is not changing which reduces power consumption. It also allows the image to continue to be displayed even after the power supply has become exhausted, allowing for a pleasing, graphical image to be continually displayed even after the power supply has run out.

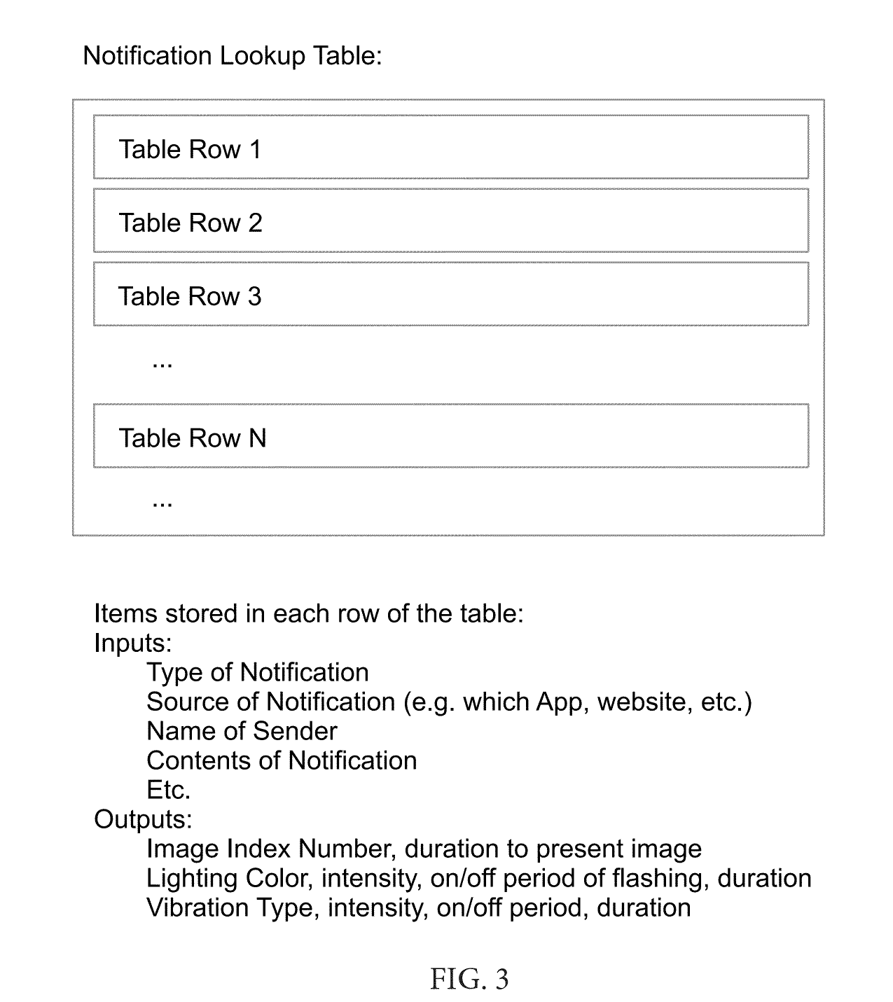

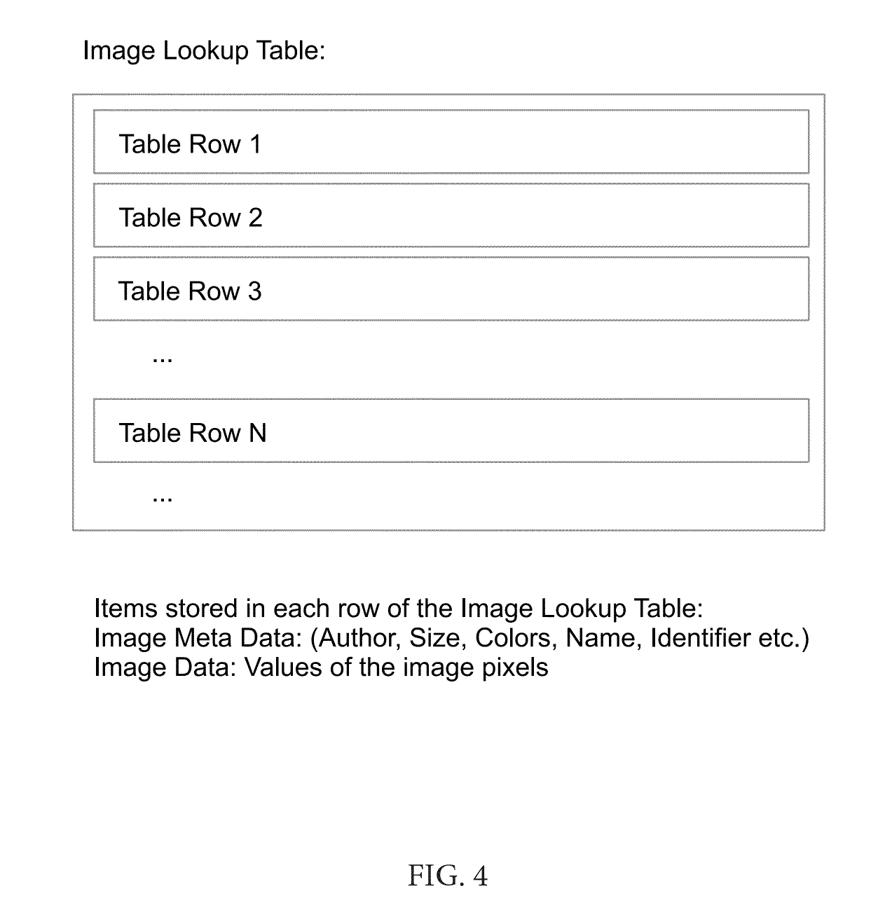

The storage may be configured to allow notification lookup tables (FIG. 3) and image lookup tables (FIG. 4) to be stored inside the jewelry piece. These tables may be accessed by the processor. Additionally, the notification look up tables and image look up tables may be configured to define how, when, and what images to display, and/or how, when, and what lights/LEDs and/or vibrations to create. The storage may be configured to maintain data even if the power supply is exhausted. For example, in some embodiments, the storage may be Flash Memory, a magnetic hard disk, or a similar device.

FIG. 3 illustrates a schematic representation of a notification look up table, according to an exemplary embodiment. As previously discussed, the notification look up table may be configured to be stored in the storage within the jewelry piece. The notification look up table may be written by the processor, normally when commanded to from the computing device, and can be read by the processor when the processor needs to decide what to display on the graphical display and/or what the lights/LEDs and/or vibrations to emit.

As shown in FIG. 3, the notification look up table may include several rows of information. Each row may include one set of data for inputs and one set of data for outputs. The inputs may be one or more of a type of notification, source of notification, name of sender of the notification, contents of the notification and/or other information representing a notification that may be sent from the computing device at a future time. The outputs may be a list of information used to control the presentation devices, including, but not limited to, one or more of an image number used to select an image from the image lookup tables), a duration to display an image, a lighting color, intensity, on/off period of flashing, duration of total display, and/or vibration type, intensity, on/off period, duration.

FIG. 4 shows a schematic representation of an image lookup table, according to an exemplary embodiment. As previously discussed, the image lookup table may be stored in the storage inside the jewelry piece. Additionally, the image lookup table can be written by the processor, and, when commanded from the computing device, may be read by the processor when the processor needs to decide what image to display on the graphical display.

FIG. 4 illustrates that the image lookup table may include several rows of information. Each row may include information for one image, including Meta Data for the image (one or more of Author, Size, Color Space, Name, Image Identifier, etc.), and the Image Data itself (describes the values of the image pixels). A row may be chosen from this table based on an image index number that may be provided by the output of the notification lookup table.

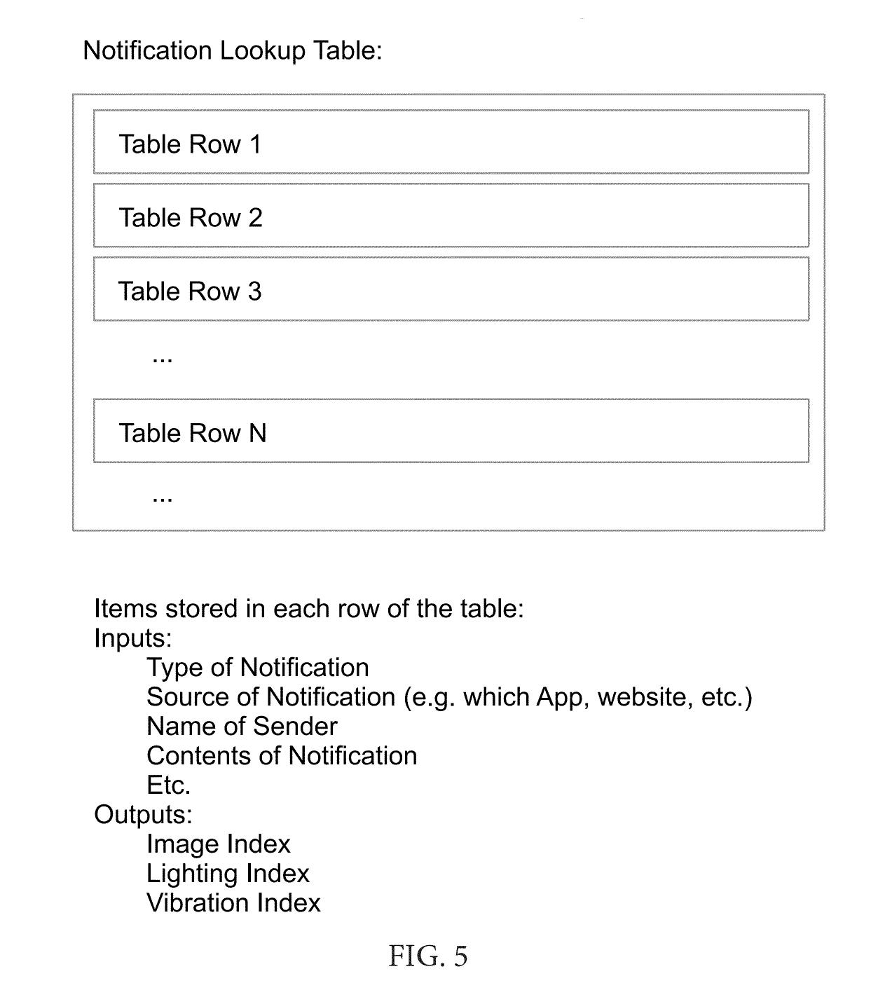

FIG. 5 shows a notification look up table, according to another exemplary embodiment. Like the notification lookup table of FIG. 3, the notification lookup table shown in FIG. 5 may include several rows, with each row including input and output information. In the embodiment of FIG. 5, the output information in each row may be an image index number, a lighting index number, and/or a vibration index number, which may be used to lookup detailed information in the image lookup table.

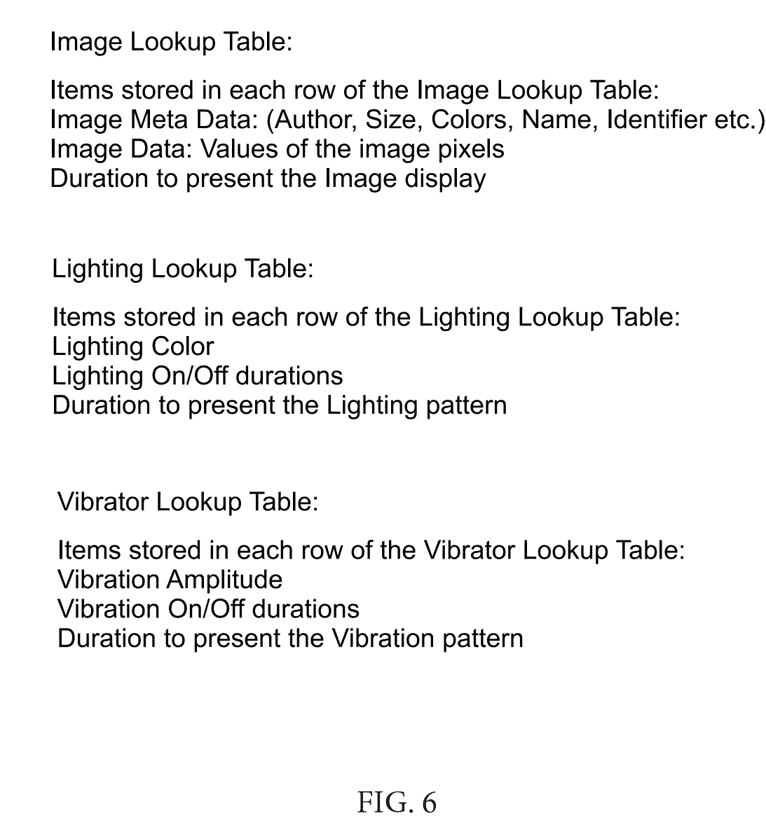

FIG. 6 shows an image lookup table, according to another exemplary embodiment. As shown in FIG. 6, in some embodiments, the image lookup table may include an image lookup table, a lighting lookup table, and/or a vibrator lookup table. Each row of the image lookup table may be identified by an image index number and may include the lighting lookup table may include a set of rows in the table, each of which contains all the information for one lighting configuration. A lighting configuration may include one or more of lighting color, lighting on/off durations, and duration to present the lighting pattern. A row may be chosen from this table based on a lighting index number provided by the output of the notification lookup table. The vibrator lookup table may include a set of rows in the table, each of which contains all the information for one vibrator configuration. This includes one or more of vibration amplitude, vibration on/off durations, and duration to present the vibration configuration. A row may be chosen from this table based on the vibrator index number provided by the output of the notification lookup table.

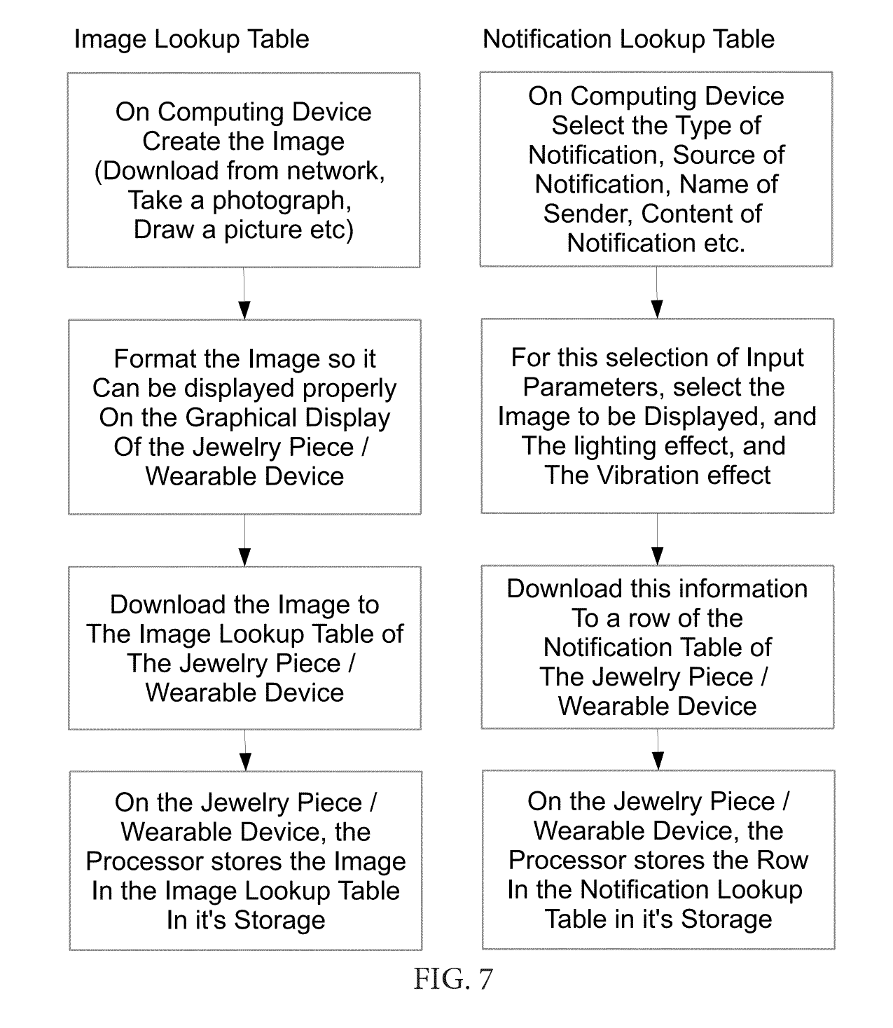

FIG. 7 shows flowcharts of how the notification lookup tables and image lookup tables may be configured, according to exemplary embodiments. It should be noted that the method illustrated in the flowchart showing how the image lookup tables are formed may also be used to form the lighting lookup table and the vibrator lookup table. As illustrated in FIG. 7, the notification lookup table and the image lookup table may be configured by the user from the computing device.

With respect to the method for creating the image lookup table, FIG. 7 illustrates that the computing device may first run a program that allows the user to select an image they wish to display. The user could select this image in many different ways, such as drawing an image themselves, selecting a photograph, searching the network for an image they like, and/or purchasing images from a store on the World Wide Web. The user may additionally want to manipulate the image in some way (e.g., crop, scale, re-color, add text, and/or combine different images) before reaching the desired image.

Once the user has selected the desired image, the computing device may process the image so it is in a suitable format to be displayed on the graphical display of the jewelry device. This might include changing the number of the image, changing the colors of the image, changing the storage format of the image, and/or adding the appropriate Meta Data.

Once the image is suitably formatted, the computing device may communicate with the jewelry piece, and send the image data and Meta Data to the jewelry piece. The processor on the jewelry piece may place the image data and Meta Data in the appropriate row of the image lookup table in the storage. In some embodiments, such as the embodiment of FIGS. 5 and 6, data may be sent to the jewelry piece and stored in the lighting lookup table and/or vibrator lookup table in a similar manner.

With respect to the method for creating the notification lookup table, FIG. 7 illustrates that the computing device may first run a program that allows the user to select information that defines a particular subset of notifications that may be generated by the computing device. This subset can be defined by selecting the notification type, the source of the notification (e.g., which application or web site generated the notification), the name of the sender (e.g., who sent the notification), and/or the content of the notification (e.g., title or keywords contained in the notification). For example, in some embodiments, the user might select a subset as: “All email received from Yahoo, which were sent by John Doe”; or “All social media notifications from Facebook from any Sender.”

Once the subset is defined by the user, the user can also select which image to display when this kind of notification is received, and what lighting effect to display, and what vibration effect should be presented. The user may also define an image that will be displayed at all other times (i.e. when there is no notification from the computing device). This image may also be saved into the notification lookup table and the image lookup table with the list of notifications/images.

Once the user has defined these settings, the computing device may format the information into a form suitable for the notification lookup table. The “notification type” information may be the inputs in the table row, and the “display information” may be the outputs in the table row.

Once this information is suitably formatted, the computing device may communicate with the jewelry piece and send the notification lookup table information to the jewelry piece. The processor on the jewelry piece may be configured to place the information into the notification lookup table in the storage.

After the configuration of the information in the jewelry piece is complete, the jewelry piece may be configured to enter operational mode. In this mode the jewelry piece may enter a low power mode where it consumes very little power, and occasionally wakes-up to monitor communication from the computing device. If the computing device has a notification it wants to send to the jewelry piece, the jewelry piece will detect this and receive the information on the notification.

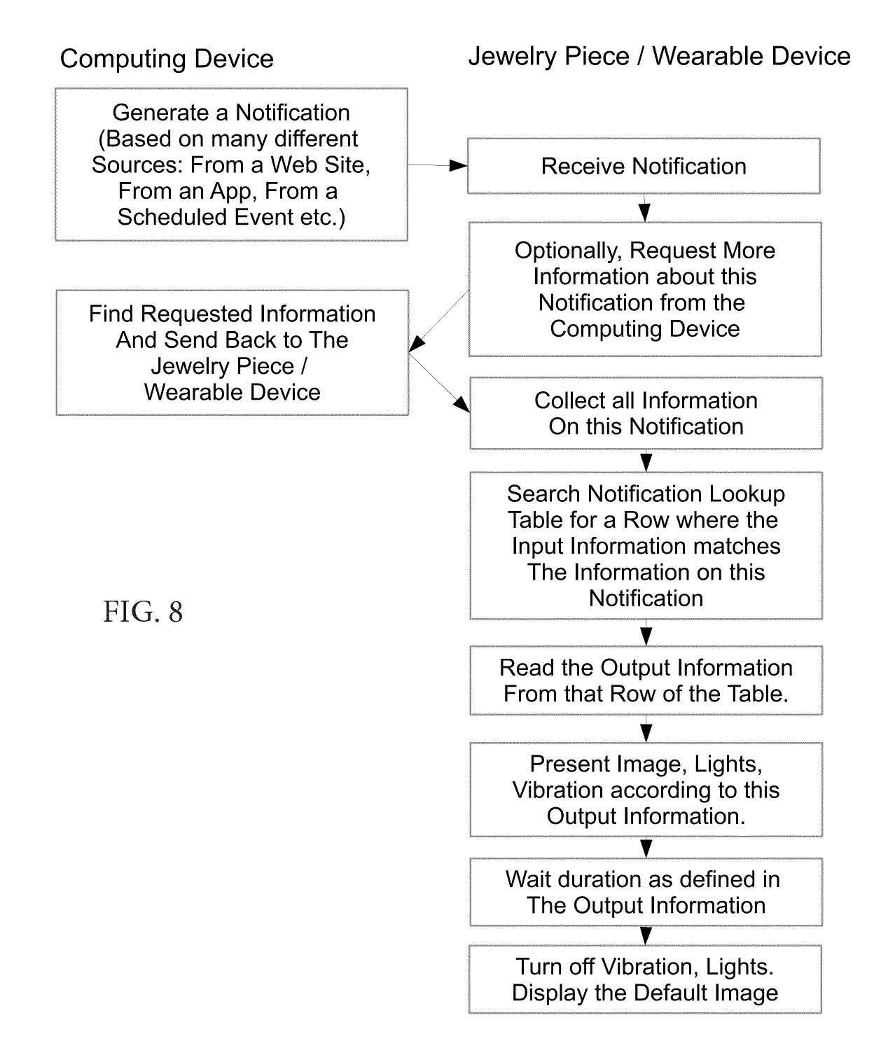

FIG. 8 shows a flowchart of how the processor on the jewelry piece handles the information received from the computing device, and how it then presents the desired outputs on the graphical display, lights/LEDs and/or vibrator.

As illustrated in FIG. 8, the computing device may first create a notification. This notification could be triggered by one of a multitude of different possible events. A few examples of events that might trigger the computing device to create a notification may include, but are not limited to: someone posts a message to a social media web site; the email application on the computing device receives an email; the smartphone receives an incoming phone call; the calendar application on the computing device indicates that a meeting is about to start; and/or a game on the computing device signals that you have moved up a level. There are many other events that can create notifications as are known to those skilled in the art.

The computing device may be configured to send the basic information about the notification to the jewelry piece. The processor on the jewelry piece wakes up and sees the kind of notification information it has received. Optionally, the processor may request more information on this notification from the computing device. The processor may be configured to create a message requesting the extra information and sends it back to the computing device. In some embodiments, if the Processor decides it does not need extra information it skips the request to the computing device, and skips waiting for the extra information, and immediately moves on to searching the tables.

After the computing device receives the request, and gathers the information if it is able to provide that information, it may be configured to send another message back to the jewelry piece containing this extra information. When the processor on the jewelry piece receives the extra information it starts to search the tables. First it searches through the notification lookup table. The processor matches the information it has just received about the new notification against the inputs on each row of the table. When it finds a table row that matches the information it selects that row of the table.

The processor then reads the outputs from the selected row of the notification lookup table. In the first alternative format for the tables, these outputs define most of the information to control the presentation devices. One item in the outputs is an index into the image lookup table. This index provides the row number to use from this table. The processor finds the row in the image lookup table, which is indicated by this index number. The processor then reads the image data out of the image lookup table.

The processor uses the image data and the other outputs from the notification lookup table to control the presentation devices as commanded. It writes the selected image to the graphical display; it turns on the lights/LEDs at the selected times with the selected colors; and/or it turns on the vibrator at the selected times with the selected amplitude. The processor waits the duration defined in the tables, and then turns off the lights/LEDs and vibrator, and returns the normal image to the graphical display.

When no notification is received, the processor will search the notification lookup table for the normal settings. This is a row in the table that indicates no notification is present, and will provide a set of outputs that shall be presented in this normal case. This normal case will usually turn off the lights/LEDs and the vibrator (to save power and to avoid annoying the user) but will display a selected Image on the graphical display.

Once the normal image has been displayed, the jewelry piece will enter it's lower power state again, and wake up occasionally to monitor communications from the computing device. When the next notification is received it will repeat the process just described (FIG. 8).

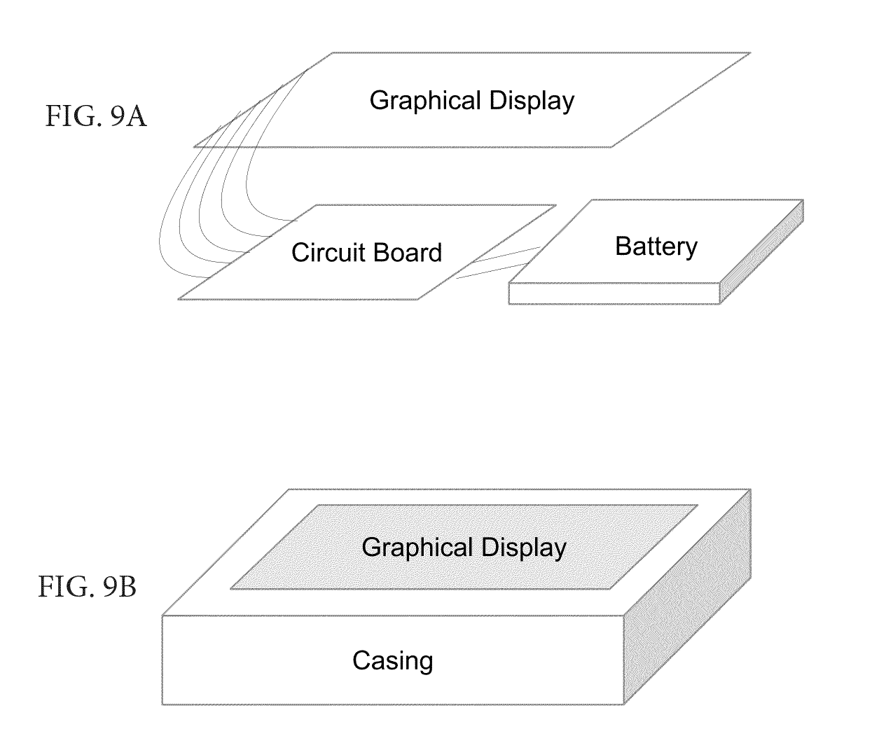

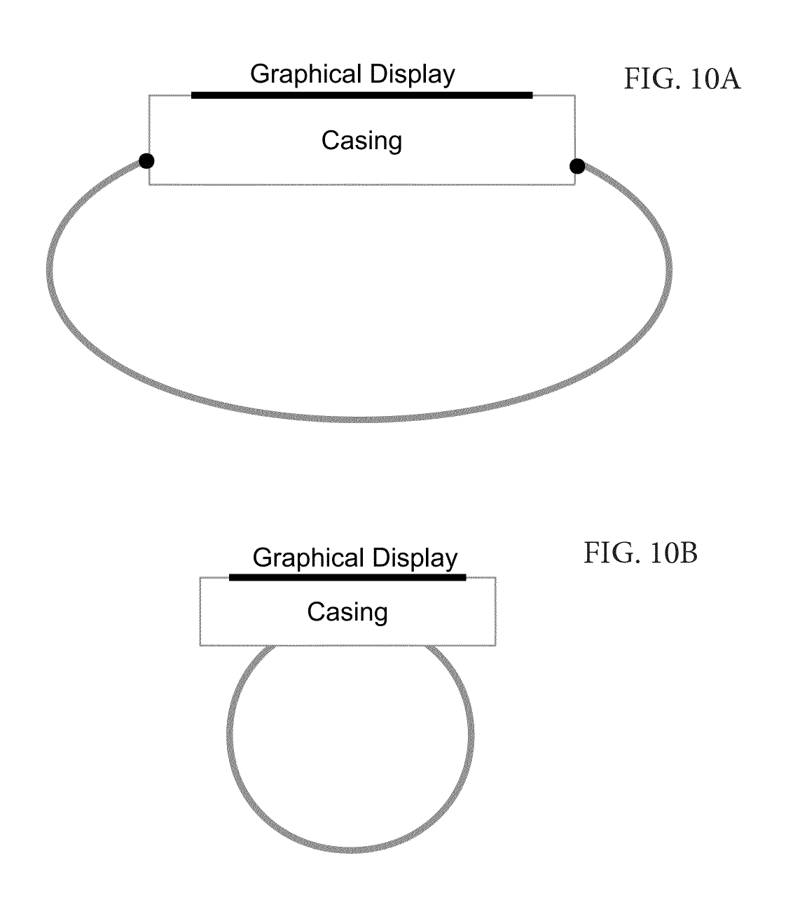

FIGS. 9A and 9B and 10A and 10B show an implementation of a jewelry piece, according to an exemplary embodiment. For example, FIG. 9A shows that in some embodiments, the electronic subsystem may include a graphical display that may be connected with wires to a circuit board. In this example the circuit board may contain all other components shown in FIG. 2 except the battery, which may be mounted next to the circuit board and attached with wires to the circuit board.

FIG. 9B shows that in some embodiments, the electronic subsystem is packaged into a casing. The graphical display may be mounted in such a way that it is easily visible. This casing may include any designs desired by those skilled in the art for use as jewelry.

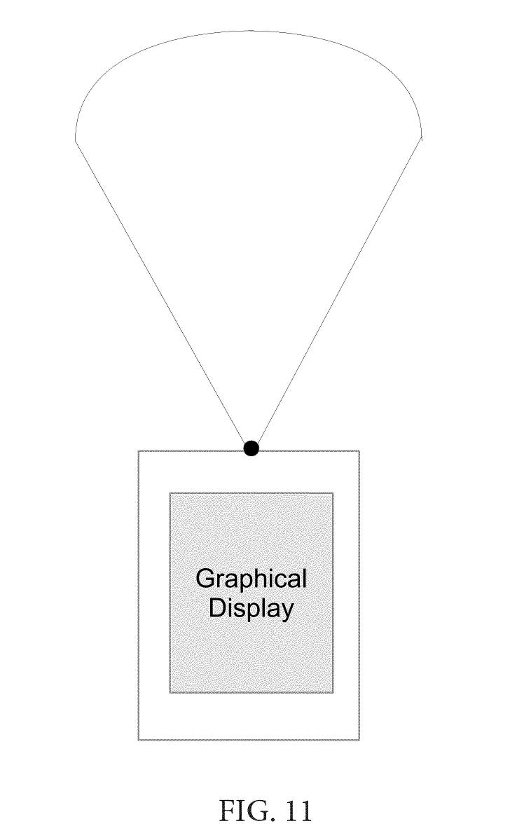

FIG. 10A shows that in some embodiments, the casing can then be mounted on a bracelet so it can be easily worn. There are many designs that could be created for the bracelet, and there are many other mountings that could be used. FIG. 10B shows that in some embodiments, the casing can then be mounted on a ring so it can be easily worn. There are many designs that could be created for the ring, and there are many other mountings that could be used. FIG. 11 shows that in some embodiments, the casing can then be mounted on a pendant so it can be easily worn. There are many designs that could be created for the pendant, and there are many other mountings that could be used.

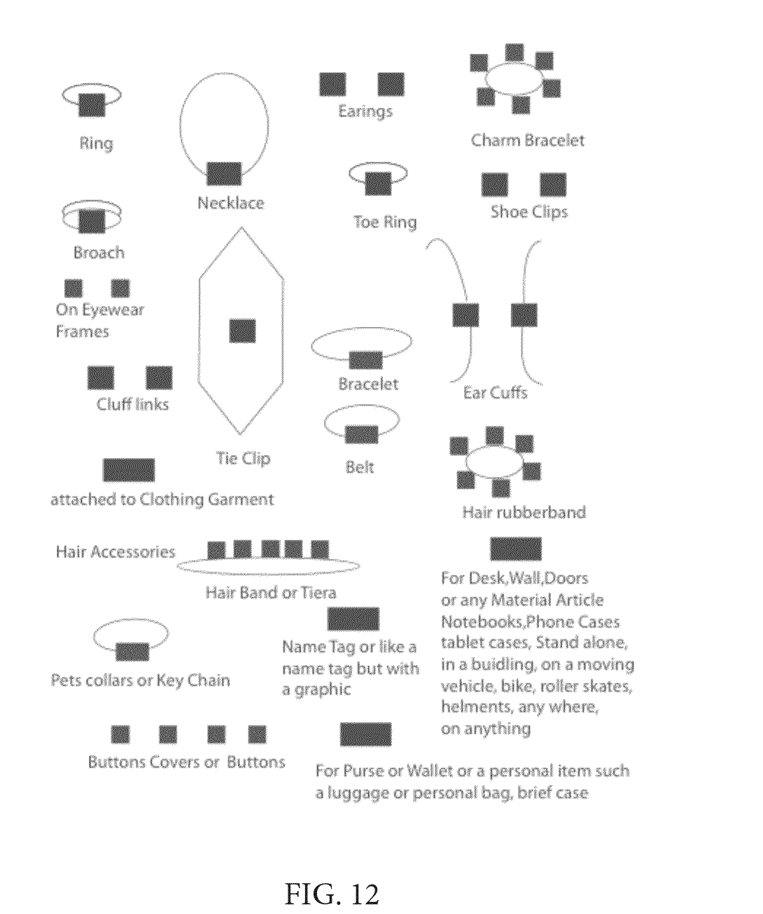

Additionally, FIG. 12 shows more example mountings for the jewelry piece. As can be seen, there are many options for mounting the jewelry piece.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention

What is claimed:

1. A jewelry piece for displaying images, comprising:
a graphical display configured to display a plurality of images;
a casing configured to house the graphical display, wherein the casing is configured to mount to an object to form the jewelry piece; and
a processor configured to receive a notification from a computing device and output an image on the graphical display based on the received notification.

2. The jewelry piece of claim 1, wherein the object is a bracelet.

3. The jewelry piece of claim 1, wherein the object is a watch.

4. The jewelry piece of claim 1, wherein the object is a ring.

5. The jewelry piece of claim 1, wherein the object is a necklace.

6. The jewelry piece of claim 1, further comprising a storage, wherein the storage is configured to store a notification lookup table and an image lookup table.

7. The jewelry piece of claim 1, wherein the notification lookup table includes information corresponding to a plurality of types of notifications and a matching plurality of image index numbers.

8. The jewelry piece of claim 7, wherein the image index numbers corresponds to images on the image lookup table.

9. The jewelry piece of claim 8, wherein the processor is configured to compare the received notification to the types of notifications on the notification lookup table and output an image on the graphical display that corresponds to the image index number that matches the received notification.

10. A method for displaying an image on a jewelry piece, comprising:
receiving a notification from a computing device via a processor, wherein the processor is located in a graphical display that is housed in a casing mounted on the jewelry piece;
matching the received notification to one of a plurality of notifications listed on a notification lookup table;
identifying an image index number that corresponds to the matched notification;
matching the image index number to one of a plurality of images listed on an image lookup table; and
displaying the image on the graphical display.

11. The method of claim 10, wherein displaying the image includes displaying the image for a predetermined duration;

12. The method of claim 10, wherein displaying the image includes displaying one or more lights on the graphical display for a predetermined time and at a predetermined intensity that corresponds to the received notification.

13. The method of claim 10, wherein displaying the image includes emitting a vibration for a predetermined duration and at a predetermined intensity that corresponds to the received notification.

14. The method of claim 10, wherein the notification is a user-defined notification.
